(19) United States
(12) Patent Application Publication
(10) Pub. No.: US 2025/0320761 A1
(43) Pub. Date: Oct. 16, 2025

(54) DESIGN KIT FOR PRODUCING AN AUTOMATIC SLIDING DOOR AND METHOD FOR PREPARING THE PRODUCTION OF AN AUTOMATIC SLIDING DOOR

(71) Applicant: dormakaba Deutschland GmbH, Ennepetal (DE)

(72) Inventors: Bernd CZAJA, Ennepetal (DE); Thomas IRRGANG, Ennepetal (DE)

(21) Appl. No.: 19/174,372

(22) Filed: Apr. 9, 2025

(30) Foreign Application Priority Data
Apr. 11, 2024 (EP) 24169775.4

(51) Int. Cl. E05F 15/643; B65D 71/02; B65D 77/04; B65D 85/64; G06Q 30/0601

(52) U.S. Cl. CPC E05F 15/643; B65D 71/02; B65D 77/042; B65D 85/64; G06Q 30/0621; B65D 2585/641; E05Y 2900/132

(57) ABSTRACT

A design kit for producing an automatic sliding door for a building, includes at least the following assemblies: at least one door assembly with a number of door assembly elements for at least one sliding door leaf, a drive assembly with a number of drive assembly elements, a motor assembly with a number of motor assembly elements, wherein the design kit is divided into a number of packages.

### CROSS-REFERENCE TO RELATED APPLICATIONS

This application claims the benefit of European patent application 24169775.4, filed on 11 Apr. 2024, the disclosure of which is incorporated herein by reference in its entirety.

### TECHNICAL FIELD

The disclosure relates to a design kit for producing an automatic sliding door for a building. The disclosure also relates to a method for preparing the production of an automatic sliding door for a building.

### BACKGROUND

Automatic sliding doors are used to close an opening in a building, e.g. at a building entrance. In the prior art, a large number of individual parts are often put together for this purpose and they have to undergo further processing steps in order to produce the automatic sliding door.

### SUMMARY

The present disclosure provides a design kit for producing an automatic sliding door for a building that can be put together and sent with as little effort as possible. The design kit should also make it as easy as possible to produce the automatic door. A method for the simplest possible preparation for the production of the automatic sliding door for the building will also be indicated.

This advantage is achieved by providing the features of the independent claims. The dependent claims relate to preferred configurations of the disclosure.

This advantage is achieved by providing a design kit for producing an automatic sliding door for a building. The design kit comprises at least the following assemblies: at least one door assembly, one drive assembly and one motor assembly.

The door assembly comprises a plurality of door assembly elements for producing at least one sliding door leaf of the automatic sliding door. As will be described later, the sliding door to be produced can also have two sliding door leaves such that the door assembly can comprise the door assembly elements for two sliding door leaves. Additionally or alternatively, the sliding door can comprise at least one stationary side part, as will also be described.

The door assembly elements preferably comprise a plurality of door profiles and/or a plurality of door seals. The door assembly elements particularly preferably comprise door profiles and door seals. Furthermore, the door assembly elements can also comprise small door parts, in particular connection elements such as screws. A door leaf, e.g. a glass pane, is also required to produce the individual sliding door leaf. This door leaf is preferably not part of the design kit described here.

The door profiles are preferably designed to form a frame around the door leaf, in particular all the way around. For this purpose, the door profiles can be connected to each other at the corners, e.g. by means of the connection elements that are to be assigned to the small door parts.

The door seals are preferably designed to be fastened to the door profiles. The door seals can thereby be the seals between the door profiles and the door leaf or can be arranged on the outside of the door profiles, for example to seal at the main or secondary closing edge or against the floor.

The drive assembly comprises a plurality of drive assembly elements. The drive assembly elements preferably comprise a cladding and/or a drive profile. The drive assembly elements particularly preferably comprise the cladding and the drive profile.

In addition, the drive assembly elements can optionally comprise a mounting plate. It is conceivable that the drive assembly elements optionally comprise a running profile. The drive assembly elements can also comprise small drive parts, such as connection elements, e.g. screws or cables.

The mounting plate is preferably designed to be fastened above the sliding door on the building side, e.g. on the lintel. Furthermore, the mounting plate and the drive profile are preferably designed such that the drive profile can be fastened to the mounting plate. The drive profile is used to support at least one carriage. The cladding is preferably designed to cover the drive profile and elements located therein, such as the motor unit or the carriages. For this purpose, the cladding is designed in particular for fastening to the drive profile and/or the mounting plate.

If a running profile is present, the running profile is preferably designed to be placed, in particular glued, onto a corresponding surface of the drive profile. The running profile serves as a running surface for at least one carriage of the automatic sliding door.

The motor assembly comprises a plurality of motor assembly elements. The motor assembly elements comprise the motor unit and at least one carriage. The at least one carriage is designed to fasten the individual sliding door leaf to the drive profile and to guide it in a sliding motion, with the carriage(s) resting on the running profile and/or on the drive profile. In particular, one carriage or two carriages are provided for each sliding door leaf.

Furthermore, it is preferably provided that the at least one carriage can be drivingly connected to the motor unit, e.g. via a belt. This means that the motor unit can be used to automatically move the at least one sliding door leaf.

The design kit provides that the assemblies, i.e. in particular the individual assembly elements, are divided into a plurality of packages. “Assembly elements” is used as a generic term for the door assembly elements, drive assembly elements and motor assembly elements.

In particular, a package means a unit with its own outer packaging. The outer packaging is formed in particular by a cardboard box and/or a film and/or packaging tapes. A cardboard box is particularly preferably used. This outer packaging allows the individual package to be transported and sent as one “part”.

The design kit is in particular intended to be sent. The recipient takes further steps to produce the automatic sliding door system or prepare the production thereof. This includes the recipient at least partially unpacking the packages or forwarding them on, e.g. for coating. The recipient usually receives the forwarded packages or the assembly elements contained therein back such that the recipient can set up the sliding door system.

The fact that a design kit is provided means that the necessary assembly elements have already been put together such that an automatic sliding door can be easily produced, in particular by adding at least one glass pane. The division of the assembly elements into a plurality of packages takes account of the fact that the individual assembly parts have different spatial dimensions. By dividing into a plurality of packages, unnecessary packaging space is avoided during sending.

A plurality of assembly elements are preferably compiled in one package. For example, a plurality of assembly elements can be compiled in at least two packages of the design kit. A plurality of assembly elements are particularly preferably compiled in the plurality of the packages. In one exemplary embodiment, a plurality of assembly elements are compiled in each of the packages. This avoids unnecessary packaging material. In addition, the recipient of the design kit can more easily assign the assembly elements to the design kit.

Preferably, associated assembly elements of an assembly are compiled in such a package. Thus, the arrangement of corresponding assembly elements in individual packages enables associated assembly elements to be compiled in such a package and can therefore be easily assigned to the correct assembly by the recipient of the design kit.

In a preferred configuration, it is provided that at least one package is provided for each assembly of the design kit. As will be described in detail, a plurality of packages are preferably provided for at least one assembly. In particular, a plurality of packages can be provided for the door assembly and/or the drive assembly. Preferably, a plurality of packages are provided for at least two of the assemblies, in particular for the door assembly and the drive assembly.

Furthermore, it is preferably provided that a package bundle is formed from at least two packages of the assembly for at least one assembly, in particular for the door assembly and/or the drive assembly. Preferably, a package bundle is formed from at least two packages for at least two assemblies, in particular for the door assembly and the drive assembly. Particularly preferably, exactly one package bundle is formed from at least two packages of the assembly for at least one assembly, in particular for the door assembly and/or the drive assembly. For example, exactly one package bundle is formed from at least two packages of the assembly for at least two assemblies, in particular for the door assembly and the drive assembly.

The package bundle has its own composite packaging. The composite packaging can be made of cardboard and/or film and/or packaging tapes. Particularly preferably, the composite packaging can be formed from packaging tapes. By forming package bundles, it is possible, even if the group elements of an assembly are divided into a plurality of packages, to compile these packages to form a package bundle such that a package bundle, in particular exactly one package bundle, is present for the respective assembly. The package bundle forms a “part” that can be transported and sent independently.

Preferably, a package bundle or a package can be provided for each assembly. Particularly preferably, exactly one package bundle or exactly one package can be provided for each assembly. For example, a package, in particular exactly one package, or a package bundle, in particular exactly one package bundle, can be provided for the motor assembly.

It is preferably provided that the door assembly elements are subdivided into first door assembly elements and second door assembly elements. It is particularly preferably provided that there are only first door assembly elements and second door assembly elements, but no further door assembly elements. This means that all door assembly elements of the door assembly are either first door assembly elements or second door assembly elements.

Preferably, the packages provided comprise a first door package and a second door package. The first and second door packages each comprise door assembly elements. In particular, all door assembly elements are divided between these two door packages and no further door packages are provided.

Preferably, the first and second door packages each exclusively comprise door assembly elements.

First door assembly elements, in particular all first door assembly elements, are arranged in the first door package. The first door assembly elements include in particular all door profiles. The first door assembly elements are preferably intended for coating and/or designed for coating. The first door assembly elements are preferably all made of metal. Coating means that these first door assembly elements must be coated, e.g. painted, before they are put together to form the sliding door leaf.

It is particularly preferably provided that a corresponding marking, preferably a sticker or an imprint, is provided on the outside of the outer packaging of the first door package, which describes that this first door package contains parts that are intended for coating. The marking may include, for example, a symbol and/or words to describe that this first door package contains parts that need to be coated. This has the advantage that the recipient of the design kit can continue to transport the first door package without opening it in order to carry out the coating.

In particular, all second door assembly elements are located in the second door package. The second door assembly elements include in particular the door seals. Optionally, the second door assembly elements can include the small door parts. In particular, these second door assembly elements are not intended for coating. The door seals are preferably produced from plastic.

It is preferably provided that the first and second door packages have the same length and/or the same width. In particular, the length of the first and second door package is at most 3.0 m, preferably at most 2.8 m, particularly preferably at most 2.6 m, in order to enable easy sending. As the two door packages have the same length and/or the same width, they can be easily put together to form a package bundle. The length of the door packages is preferably at least 0.75 m, particularly preferably at least 1.0 m.

Preferably, the first and second door packages form a package bundle, in particular a package bundle that is held together with packaging tapes.

It is preferably provided that the drive assembly elements are subdivided into at least a first drive assembly element and a second drive assembly element, preferably into first drive assembly elements and second drive assembly elements. It can also be provided that the drive assembly elements are subdivided into a first drive assembly element and a plurality of second drive assembly elements.

It is particularly preferably provided that there are only the first drive assembly element or the first drive assembly elements and the second drive assembly element or the second drive assembly elements, but no further drive assembly elements. This means that all drive assembly elements of the drive assembly are either first drive assembly elements or second drive assembly elements.

Preferably, the packages provided comprise a first drive package and a second drive package. The first and second drive packages each comprise drive assembly elements. In particular, all drive assembly elements are divided between these two drive packages and no further drive packages are provided.

Preferably, the first and second drive packages each comprise only drive assembly elements.

First drive assembly elements, in particular all first drive assembly elements, are arranged in the first drive package. If only a first drive assembly element is present, the first drive assembly element is arranged in the first drive package. The first drive assembly element(s) includes, in particular, the cladding. The first drive assembly element or the first drive assembly elements are preferably provided for coating and/or designed for coating. The first drive assembly element or the first drive assembly elements are preferably made of metal. If there are a plurality of first drive assembly elements, they are preferably all made of metal. Coating means that these first drive assembly element(s) must be coated, e.g. painted, before they are put together to form the sliding door.

It is particularly preferably provided that a corresponding marking, preferably a sticker or an imprint, is provided on the outside of the outer packaging of the first drive package, which describes that this first drive package contains parts that are intended for coating. The marking may include, for example, a symbol and/or words to describe that this first drive package contains parts that need to be coated. This has the advantage that the recipient of the design kit can continue to transport the first drive package without opening it in order to carry out the coating.

Second drive assembly elements, in particular all second drive assembly elements, are located in the second drive package. The second drive assembly elements include at least the drive profile. If a mounting plate is present, the mounting plate is one of the second drive assembly elements. If a running profile is present, the running profile is one of the second drive assembly elements. The second drive assembly elements can optionally include the small drive components. In particular, these second drive assembly elements are not intended for coating.

It is preferably provided that the first and second drive packages have the same length and/or the same width. In particular, the length of the first and second drive package is at most 2.8 m, preferably at most 2.6 m, particularly preferably at most 2.35 m, in order to enable easy sending. The length of the drive packages is preferably at least 0.75 m, particularly preferably at least 1.0 m. The fact that the two drive packages have the same length and/or the same width means that they can be easily put together to form a package bundle.

Preferably, the first and second drive packages form a package bundle, in particular a package bundle that is held together with packaging tapes.

Preferably, the motor assembly also comprises as motor assembly elements a locking unit and/or a battery unit in addition to the motor unit described and the at least one carriage. The locking unit is present in particular if the sliding door is intended to be lockable. The battery unit is present in particular if an emergency operation of the sliding door is provided. The motor assembly elements can optionally include small motor parts such as connection elements.

The packages of the design kit preferably comprise a plurality of motor assembly packages. This plurality of motor assembly packages are preferably compiled to form a package bundle. The package bundle is preferably formed by a composite packaging made of cardboard.

Preferably, a motor assembly package is provided for the motor unit and a further motor assembly package for the at least one carriage. If a plurality of carriages are used, they can also be divided into a plurality of motor assembly packages. Another motor assembly package can optionally receive the locking unit. Another motor assembly package can optionally receive the battery unit. A separate motor assembly package can be provided for the small motor parts, or the small motor parts can be included in one of the other motor assembly packages.

Alternatively, the motor assembly elements, preferably all motor assembly elements, are arranged in a motor assembly package.

It may be that the sliding door comprises at least the stationary side part. The design kit can comprise at least one side assembly with a plurality of side assembly elements for a side part.

If a plurality of side parts are present, the design kit can comprise a plurality of side assemblies.

The side assembly elements preferably comprise a plurality of side part profiles and/or a plurality of side part seals. The side assembly elements particularly preferably comprise side part profiles and side part seals. Furthermore, the side assembly elements can also comprise small side part components, in particular connection elements such as screws. A wall element, e.g. a glass pane, is also required to produce the individual side part. This wall element is preferably not part of the design kit described here. If side assembly elements are present, the generic term “assembly elements” preferably also includes the side assembly elements.

It is preferably provided that the side assembly elements are subdivided into first side assembly elements and second side assembly elements. It is particularly preferably provided that there are only first side assembly elements and second side assembly elements, but no further side assembly elements. This means that all side assembly elements of the side assembly are either first side assembly elements or second side assembly elements.

Preferably, the packages provided comprise a first side package and a second side package. The first and second side packages each comprise side assembly elements. In particular, all side assembly elements are divided between these two side packages and no further side packages are provided.

Preferably, the first and second side packages each exclusively comprise side assembly elements.

First side assembly elements, in particular all first side assembly elements, are arranged in the first side package. The first side assembly elements include, in particular, all side part profiles. The first side assembly elements are preferably intended for coating and/or designed for coating. The first side assembly elements are preferably all made of metal. Coating means that these first side assembly elements must be coated, e.g. painted, before they are put together to form the side part.

It is particularly preferably provided that a corresponding marking, preferably a sticker or an imprint, is provided on the outside of the outer packaging of the first side package, which describes that this first side package contains parts that are intended for coating. The marking may include, for example, a symbol and/or words to describe that this first side package contains parts that need to be coated. This has the advantage that the recipient of the design kit can continue to transport the first side package without opening it in order to carry out the coating.

In particular, all second side assembly elements are located in the second side package. The second door assembly elements include, in particular, the side part seals. Optionally, the second side assembly elements can include the small side part components. In particular, these second side assembly elements are not intended for coating. The side part seals are preferably produced from plastic.

It is preferably provided that the first and second side packages have the same length and/or the same width. In particular, the length of the first and second side package is at most 3.0 m, preferably at most 2.8 m, particularly preferably at most 2.6 m, in order to enable easy sending. The length of the side packages is preferably at least 0.75 m, particularly preferably at least 1.0 m. The fact that the two side packages have the same length and/or the same width means that they can be easily put together to form a package bundle.

Preferably, the first and second side packages form a package bundle, in particular a package bundle that is held together with packaging tapes.

It is preferably provided that the design kit is designed to be modified after receipt and before putting the automatic sliding door together. Modification in this context in particular means all steps that cannot be assigned to the assembly, i.e. not to the connection of individual components. Modification means in particular that the design kit, i.e. at least one assembly element of the design kit, is/are shortened in length and/or holes are introduced and/or is/are coated. In particular, the modification is limited to this shortening, introduction of holes and/or coating. The steps of shortening, introducing holes and coating are particularly preferably carried out. This means, in particular, that no further modifications are intended. In particular, it is not provided that any of the component elements of the design kit will have to undergo machining or cutting that goes beyond the shortening or introduction of holes.

Furthermore, it is preferably provided that at least one of the door assembly elements, in particular at least one of the door profiles, has been subjected to a material-removal method step prior to sending. In particular, it is provided that the door assembly element, in particular at least one of the door profiles, comprises a recess for receiving a floor guide rail. The recess is preferably introduced by the material-removal step before sending. This has the advantage that such a complicated modification, namely the provision of the recess, takes place before the design kit is sent.

It is preferably provided that the design kit for producing the automatic sliding door is designed as a double-leaf sliding door. This double-leaf sliding door comprises a first sliding door leaf and a second sliding door leaf. Such double-leaf sliding doors extend over a relatively long length (measured horizontally) and are intended to close correspondingly large openings in the building. The drive assembly elements present, namely the drive profile and the cladding, if present the running profile and/or the mounting plate, are correspondingly long, in particular over 2 m, as these drive assembly elements must extend over the entire length. It is therefore preferably provided that at least one drive assembly element of the design kit, in particular the drive profile and the cladding, if present the running profile and/or the mounting plate, are in two parts. The two parts of the respective drive assembly element are preferably designed to be placed together to form the final drive assembly element over its entire length. In particular, each part of the two-part configuration is shorter than 360 cm, preferably shorter than 310 cm, particularly preferably shorter than 250 cm. Each part of the two-part configuration can be designed to be longer than 75 cm, preferably longer than 100 cm.

The design kit comprises preferably at least one connection part, in particular as a drive assembly element, in order to connect two-part drive assembly elements to one another. In particular, such a connection part is provided for the cladding and/or the drive profile, preferably for the cladding and the drive profile. The mounting plate, if present, does not necessarily require a connection part, as the two parts of the mounting plate are fastened to the building and therefore only need to be placed together, but not connected. The running profile, if present, is placed, e.g. glued, on a corresponding surface of the drive profile. For this reason, the two parts of the running profile do not necessarily have to be connected to each other, but simply placed together.

For the optional configuration described below, it is also provided that the design kit for producing the automatic sliding door is designed as a double-leaf sliding door. It is preferably provided that the first and second door package each comprise the door assembly elements for both sliding door leaves. For example, preferably first door assembly elements for both sliding door leaves, in particular all first door assembly elements for both sliding door leaves, are located in the first door package. Preferably second door assembly elements for both sliding door leaves, in particular all second door assembly elements for both sliding door leaves, are located in the second door package.

It is also preferably provided that the first and second drive package each comprise the drive assembly elements for both sliding door leaves. Thus, preferably first drive assembly elements for both sliding door leaves, in particular all first drive assembly elements for both sliding door leaves, are located in the first drive package, and preferably second drive assembly elements for both sliding door leaves, in particular all second drive assembly elements for both sliding door leaves, are located in the second drive package.

The parts of the two-part drive assembly elements can be arranged next to each other in the first and second drive package. Once the two-part drive assembly elements have been assembled, however, the parts of the drive assembly elements are placed one behind the other.

The disclosure further comprises a method for preparing the production of an automatic sliding door for a building. The sliding door to be produced is the same sliding door as described in the design kit. The method is used for selecting and/or using the design kit according to the disclosure, in particular the design kit according to one of claims 1 to 11. Likewise, a design kit is protected which is designed or produced by means of the method according to the disclosure, in particular a method of claims 12 to 15, or which is produced and used according to the method of claim 16.

The method comprises:
(i) putting the design kit together as previously described and/or as defined in the claims; and
(ii) sending the plurality of packages of the design kit. In particular, it is provided that the packages and/or package bundles are put together as described in the design kit and/or as described in the claims for the design kit.

In particular, the plurality of packages of the design kit can be sent together.

Preferably, the method provides that the following steps are carried out prior to putting them together and sending.
(a) A computer arrangement is used in which data on a plurality of pre-configured design kits is stored. The computer arrangement can basically comprise one or a plurality of computers, e.g. PCs, servers or virtual servers. The individual computers of the computer arrangement can be at the same location or at different locations and are networked accordingly.

It is provided that a plurality, in particular each, of the pre-configured design kits stored in the computer arrangement correspond to the design kit as described previously and/or defined in the claims. The pre-configured design kits differ in at least one design, in particular parameters, specific to the door assembly and/or the drive assembly and/or the motor assembly. For example, these parameters can relate to the length of the door assembly elements and/or drive assembly elements. The parameters can also relate to the geometric shape of the cross-section of profiles, in particular the door profiles and/or the seals. In addition, the parameters could, for example, relate to the configuration and/or functionality of the motor unit. Additionally or alternatively, the pre-configured design kits can differ in the specification of the sliding door, e.g. single-leaf or double-leaf, with side part(s) or without side part(s).

If side parts are present, the pre-configured design kits can differ in the design, in particular the parameters, of the side assemblies, e.g. with regard to the geometric shape of the cross-section of the side part profiles and/or the side part seals.
(b) Furthermore, a configuration system operated on the computer arrangement is made available, in particular operated, as part of the method. This configuration system can be called up via a browser, for example, which accesses the data of the computer arrangement. The configuration system is designed to allow a user to select and/or indicate a plurality user specifications. These user specifications relate, for example, to the height and width of the building opening where the sliding door is to be installed. Furthermore, the user specification can, for example, relate to a selection as to whether it is a single-leaf or double-leaf door. In addition, the user specification can, for example, relate to the type of profiles to be used. The computer system receives the user selection entered in the configuration system and/or the user information entered in the configuration system.
(c) In the next method step, one of the pre-configured design kits is assigned to the actuated user specifications by means of the computer arrangement.

For this purpose, it is stored in the computer arrangement and/or can be determined by the computer arrangement which pre-configured design kit is assigned or is to be assigned to which combination of user specifications.
(d) The assigned pre-configured design kit is then issued by means of the computer arrangement, in particular with an overall order number for the entire pre-configured design kit. This issuing can mean that the user of the configuration system is shown this pre-configured, assigned design kit in the form of a number and/or description. Additionally or alternatively, the issuing can mean that the manufacturer of the design kit is sent information indicating which of the pre-configured design kits has been assigned to the user specifications.

It can be provided that the overall order number is transmitted to the user. The packages are preferably provided with the overall order number. Alternatively or additionally, the packages or package bundles of the design kit are each provided with sub-order numbers. If sub-order numbers are provided on the packages, the user is given a list of the sub-order numbers listed under the overall order number.

In particular, it is provided that the design system is designed such that the user specifications to be selected and/or indicated comprise the following:

Spatial dimensions of the opening of the building to be closed by the sliding door; and/or specification of the sliding door, in particular single-leaf, double-leaf, with or without side part(s); and/or thickness of the door leaf, in particular the glass pane.

Preferably, at least the opening of the building to be closed by the sliding is one of the user specifications.

Particularly preferably, at least both the spatial dimensions of the opening of the building to be closed by the sliding door and the specification of the sliding door and the thickness of the glass pane can be entered into the configuration system as user specifications. When specifying the sliding door, it is possible to select whether the sliding door should be single or double-leaf and whether the sliding door should have side part(s). The configuration system uses these entries to select the correct design kit.

The following user specifications may also be present: Specification of the motor assembly, in particular the motor unit and/or surface quality of the profiles.

It is also conceivable that the following user specifications are present: Weight of the sliding door, seals on the sliding door; and/or further specification of the door profiles; and/or further specification of the cladding.

Furthermore, it is preferably provided that the design system is designed to determine a target length of the at least one door assembly element and/or the at least one drive assembly element based on the user specifications. The door assembly elements here are in particular the door profiles and/or door seals. The drive assembly elements here are in particular the drive profile and the cladding, optionally the mounting plate and/or the running profile. As part of the method, the at least one door assembly element and/or the at least one drive assembly element is preferably sent with an actual length that is greater than the target length. If one of the door assembly elements and/or drive assembly elements is sent in two parts, the target length and the actual length refer to the total length of the assembly element that is put together. The configuration system is preferably designed to issue an instruction that describes the shortening to the target length. For example, the configuration system issues this target length for the respective assembly element as an instruction. Based on the instruction, the recipient of the design kit can shorten the corresponding assembly element to the target length after sending and before installing the sliding door.

It can be provided that the design system is designed to determine a length and/or a width, preferably a length and a width, of the door leaf, in particular the glass pane, based on the user specifications. In particular, the design system uses at least the spatial dimensions of the opening of the building to be closed by the sliding door to determine the length and/or width of the door leaf, in particular the glass pane. The design system transfers the information of a length and/or a width of the door leaf, in particular electronically, to the user. The user who receives the information of the length and/or width of the door leaf can order the door leaf with the correct spatial dimensions such that the production of the sliding door can then proceed without complications.

The method preferably involves the following method steps:
Prior to compiling the design kit and/or prior to sending: Carrying out a material-removal step on at least one of the door profiles, in particular introducing a recess to receive a floor guide rail;
And/or after sending: Coating the first door assembly elements and/or first drive assembly elements;
And/or after sending: Shortening at least one of the door assembly elements and/or at least one of the drive assembly elements to the target length, preferably according to the instruction;
And/or after sending: Introducing at least one hole in at least one door assembly element and/or drive assembly element using a template;

In particular, the design kit can comprise the corresponding template.

Preferably all of the above steps take place.

In the case of a double-leaf sliding door, the method can comprise the following step after sending: Placing together, in particular connecting, at least one drive assembly element sent in two parts.

The method can optionally comprise the production of the sliding door.

### BRIEF DESCRIPTION OF THE DRAWINGS

The disclosure will now be described in more detail on the basis of an exemplary embodiment, in which is shown:

FIG. 1 different automatic sliding doors, produced with a design kit according to the disclosure in accordance with an exemplary embodiment,

FIG. 2 a schematic representation of an automatic sliding door produced with the design kit according to the disclosure in accordance with the exemplary embodiment,

FIG. 3 a detailed view of an automatic sliding door produced with the design kit according to the disclosure in accordance with the exemplary embodiment,

FIG. 4 a cross-section of a first door package of the design kit according to the disclosure in accordance with the exemplary embodiment,

FIG. 5 a cross-section of a second door package of the design kit according to the disclosure in accordance with the exemplary embodiment,

FIG. 6 a cross-section of a first drive package of the design kit according to the disclosure in accordance with the exemplary embodiment,

FIG. 7 a cross-section of a second drive package of the design kit according to the disclosure in accordance with the exemplary embodiment,

FIG. 8 a perspective view of a package bundle consisting of the first and second door package of the design kit according to the disclosure in accordance with the exemplary embodiment,

FIG. 9 a perspective view of a package bundle consisting of the first and second drive package of the design kit according to the disclosure in accordance with the exemplary embodiment,

FIG. 10 a perspective view of a package bundle of the motor assembly of the design kit according to the disclosure in accordance with the exemplary embodiment,

FIG. 11 schematic views of a two-part cladding of the design kit according to the disclosure in accordance with the exemplary embodiment,

FIG. 12 schematic views of a door profile of the design kit according to the disclosure in accordance with the exemplary embodiment,

FIG. 13 a schematic view of the method according to the disclosure in accordance with the exemplary embodiment, and

FIG. 14 a schematic view of a configuration system of the method according to the disclosure in accordance with the exemplary embodiment.

### DETAILED DESCRIPTION OF THE DRAWINGS

A design kit 9 for producing an automatic sliding door 1 for a building is described below on the basis of the figures. Furthermore, a method 100 according to the disclosure for preparing the production of the automatic sliding door 1 is described on the basis of the figures. Unless otherwise stated in detail, reference is always made to all figures.

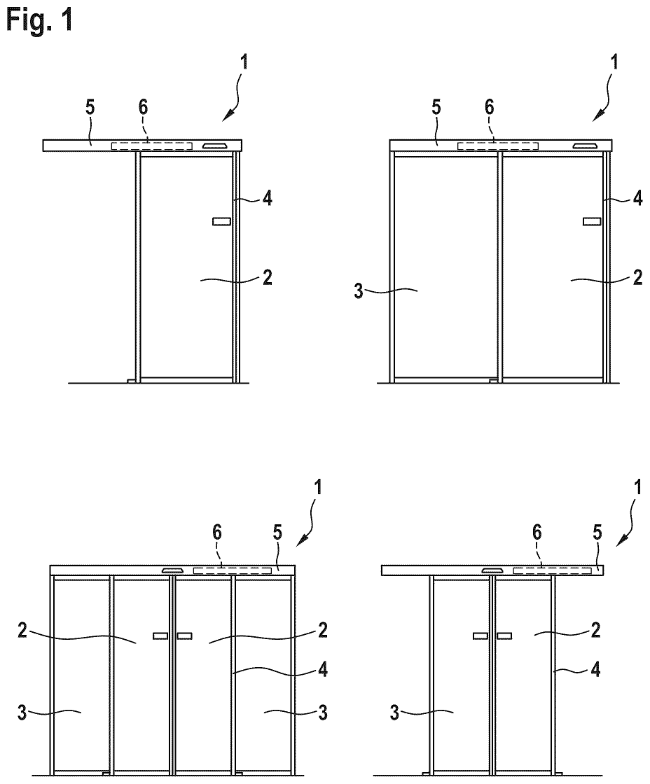

FIG. 1 shows four exemplary configurations of automatic sliding doors that can be produced using a design kit 9 according to the disclosure. The two upper representations in FIG. 1 show the sliding door 1 with a sliding door leaf 2 in each case. The upper right-hand representation shows that a stationary side part 3 can be located next to the individual sliding door leaf 2. The two lower representations in FIG. 1 show that the sliding door 1 can be configured to have two leaves with a first sliding door leaf 2 and a second sliding door leaf 2. The lower left-hand representation shows that a side part 3 can be arranged on both sides of the sliding door leaf 2.

The design kit 9 for producing the respective sliding door 1 comprises a door assembly 4. The door assembly elements for either one sliding door leaf 2 or for both sliding door leaves 2 are located in this door assembly 4. As explained in the general part of the description, the door assembly 4 of the design kit 9 does not in particular comprise the door leaf, e.g. the glass pane.

Furthermore, the design kit 9 comprises a drive assembly 5 with the associated drive assembly elements and a motor assembly with the associated motor assembly elements.

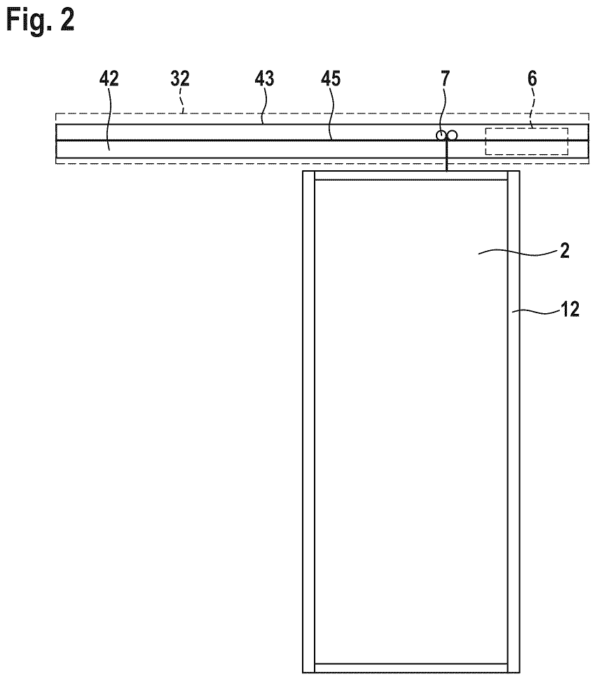

FIG. 2 shows a purely schematic view of assembly elements of the sliding door 1. It can be seen that the door assembly 4 comprises a plurality of door profiles 12, e.g. four door profiles 12 per sliding door leaf 2.

Furthermore, the schematic representation in FIG. 2 shows a motor unit 6 and a carriage 7 as components of the motor assembly. The sliding door leaf 2 hangs from the carriage 7. The respective carriage 7 is drivingly connected to the motor unit 6 via elements not represented, e.g. a belt, such that the carriage 7 and thus the sliding door leaf 2 can be moved automatically in a horizontal direction.

Furthermore, the schematic representation in FIG. 2 shows a plurality of assembly elements of the drive assembly 5. The drive assembly 5 therefore comprises a mounting plate 43 to which a drive profile 42 is fastened. A running profile 45, on which the carriage 7 rests and rolls, is located on the drive profile 42. The drive profile 42 is covered by a cladding 32.

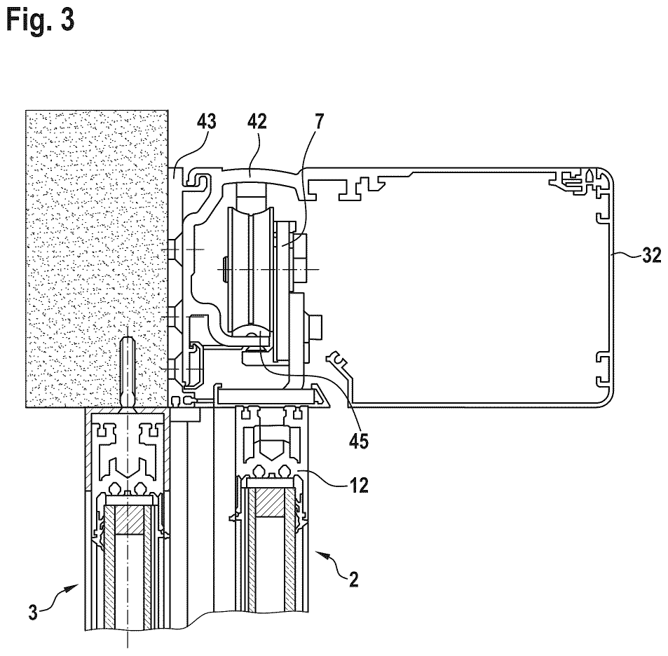

FIG. 3 shows a sectional view of the structure of the sliding door 1, which can be produced using the design kit 9. It can be seen here that the running profile 45 rests on the drive profile 42. It can also be seen that the drive profile 42 is fastened to the mounting plate 43. The cladding 32 is fastened to the drive profile 42 and covers at least the front and the lower side of the drive profile 42.

FIG. 3 also shows that the upper door profile 12 of the sliding door leaf 2 is connected to the carriage 7 and that the stationary side part 3 is fastened directly to the lintel of the building.

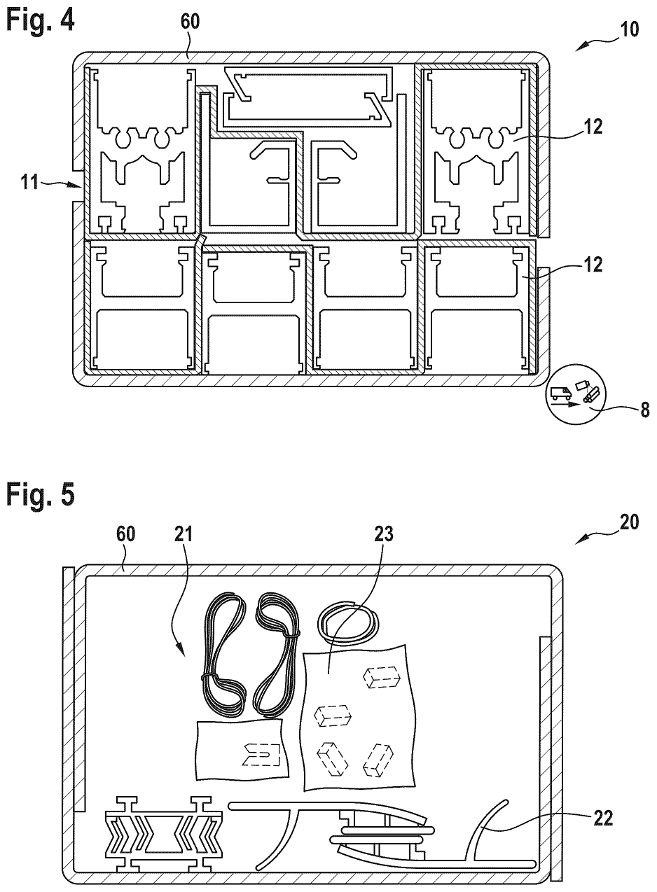

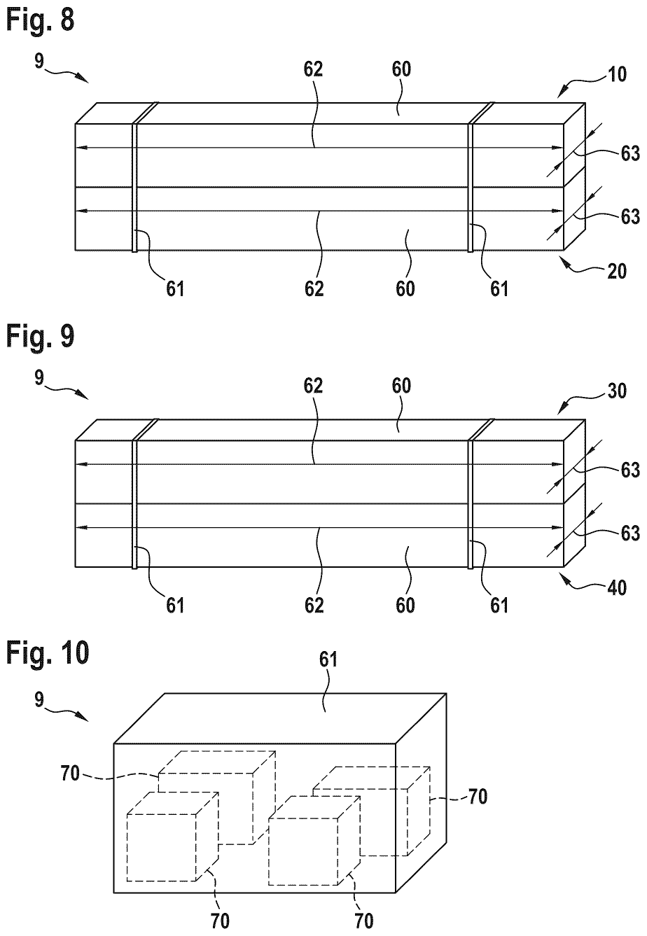

FIGS. 4 to 10 illustrate the division of the individual assembly elements of the door assembly 4, the drive assembly 5 and the motor assembly 6 into a plurality of packages. The entire design kit 9 is shown in the overall view of FIGS. 8, 9 and 10.

With regard to FIGS. 4 and 5, it should be noted that the door assembly 4 also comprises door seals 22 and small door parts 23 as door assembly elements in addition to the door profiles 12. All door assembly elements are divided into first door assembly elements 11, which include the door profiles 12, and second door assembly elements 21, which include the door seals 22 and the small door parts 23.

FIG. 4 shows a first door package 10, in which all the first door assembly elements 11, i.e. the door profiles 12, are located. Like every package presented here, the first door package 10 also comprises an outer packaging 60, made of cardboard in the exemplary embodiment shown. All first door assembly elements 11 are located inside this outer packaging 60.

FIG. 4 illustrates purely schematically that a marking 8 can be located on this first door package 10. This marking 8 graphically illustrates that the assembly elements located in the first door package 10 are to be coated.

FIG. 5 shows a second door package 20, in which all second door assembly elements 21, i.e. in particular the door seals 22 and the small door parts 23, are located. The second door package 20 also comprises an outer packaging 60 made of cardboard. All second door assembly elements 21 are located inside the outer packaging 60.

All drive assembly elements are divided into first drive assembly elements 31, which include the cladding 32, and second drive assembly elements 41, which include the drive profile 42, the mounting plate 43, the running profiles 45 and small drive parts 44.

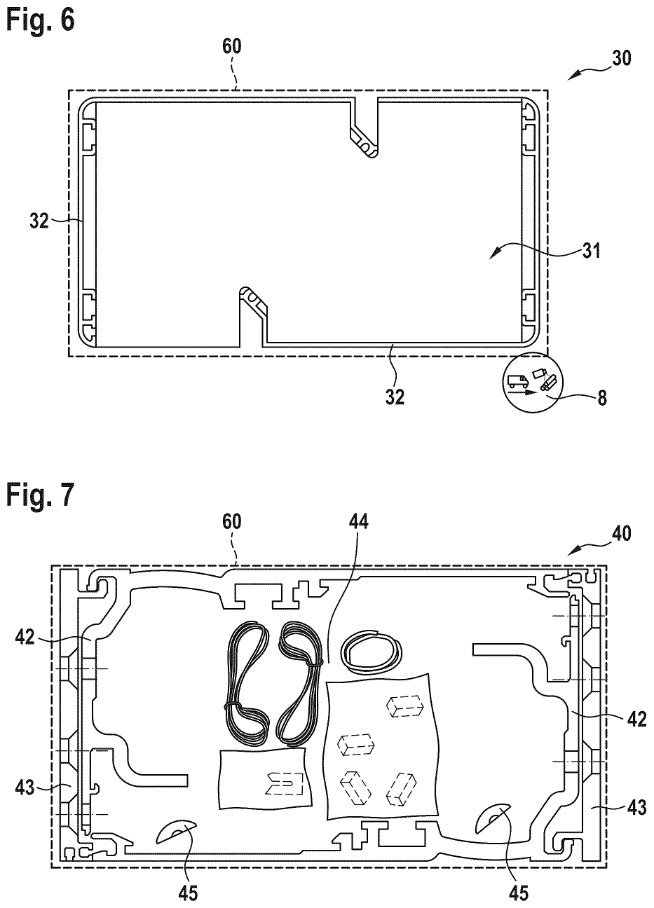

FIG. 6 shows a first drive package 30, in which all first drive assembly elements 31 are located. The first drive package 30 comprises an outer packaging 60, made of cardboard in the exemplary embodiment shown. All first drive assembly elements 31 are located inside this outer packaging 60.

FIG. 6 illustrates purely schematically that the marking 8 can also be located on this first drive package 30. This marking 8 graphically illustrates that the assembly elements located in the first drive package 30 are to be coated.

FIG. 7 shows a second drive package 40, in which all second drive assembly elements 41 are located. The second drive package 40 also comprises an outer packaging 60 made of cardboard. All second drive assembly elements 41 are located inside the outer packaging 60.

FIG. 8 shows purely schematically that the first door package 10 and the second door package 20 of the design kit 9 can be compiled to form a package bundle. This package bundle is formed by the first door package 10 and the second door package 20 being connected with a composite packaging 61. In the exemplary embodiment, the composite packaging 61 is packaging tape. Alternatively, a cardboard box and/or a film can be used here.

Furthermore, FIG. 8 shows that the first door package 10 and the second door package 20 have the same package length 62 and the same package width 63.

FIG. 9 shows purely schematically that the first drive package 30 and the second drive package 40 of the design kit 9 can be compiled to form a package bundle. This package bundle is formed by the first drive package 30 and the second drive package 40 being connected with a composite packaging 61. In the exemplary embodiment, the composite packaging 61 is packaging tape. Alternatively, a cardboard box and/or a film can be used here.

Furthermore, FIG. 8 shows that the first drive package 30 and the second drive package 40 have the same package length 62 and the same package width 63.

FIG. 10 shows, purely schematically, a plurality of motor assembly packages 70 in which individual motor assembly elements of the motor assembly are located. As FIG. 10 illustrates, it is provided in particular that all motor assembly packages 70, and thus all motor assembly elements of the motor assembly, are located in a package bundle as part of the design kit 9. The composite packaging 61 used here is, in particular, a cardboard box in which all motor assembly packages 70 are located. Alternatively, and not represented, a single motor assembly package can be provided in which the motor assembly elements are located.

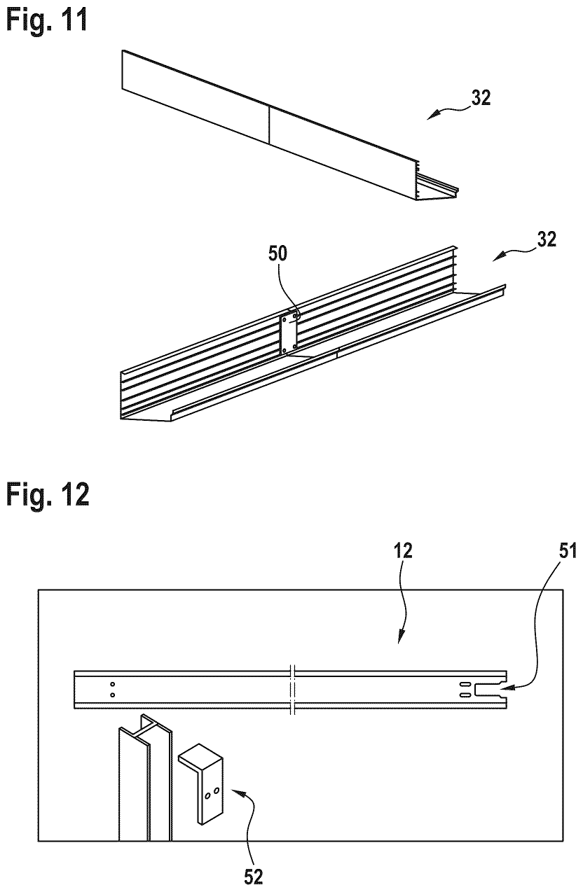

FIG. 11 shows purely schematic the cladding 32 of the drive assembly 5. According to FIG. 11, the cladding 32 can be configured in two parts, which is particular useful if a double-leaf sliding door 1 is to be produced with the design kit 9. In this case, the building opening (measured horizontally) is relatively large, such that the drive assembly elements, namely drive profile 42, mounting plate 43, running profile 45 and cladding 32, must also extend over a correspondingly large length. In order to simplify the handling of these drive assembly elements, it is preferably provided that these drive assembly elements are designed in two parts, as shown in FIG. 11 using the cladding 32 as an example. In the two-part embodiment, a corresponding connection part 50 is provided in particular for the cladding 32 and/or for the drive profile 42 in order to produce the corresponding drive assembly element in its entire length from the two-part configuration.

Drive packages 30, 40 are represented in FIGS. 6 and 7 in which the drive assembly elements, namely the drive profile 42, the mounting plate 43, the cladding 32 and the running profile 45, are configured in two parts. As a result, both parts of the two-part cladding 32 are represented in cross-section in the first drive package in FIGS. 6 and 7. The two parts of the cladding 32 are arranged next to each other and rotated relative to each other in the first drive package. On the other hand, the two parts of the cladding 32 are arranged one behind the other in the assembled state, as represented in FIG. 11. Accordingly, the two parts of the two-part mounting plate 43 are arranged opposite each other and the two parts of the drive profile 42 in the second drive package 40 are arranged next to each other and rotated relative to each other. After assembly, the two parts of the mounting plate 43 and the drive profile 42 are arranged one behind the other.

FIGS. 4 to 10 together show a design kit 9 of a double-leaf sliding door 1 without side parts 3, as represented in FIG. 1 bottom right. Accordingly, the door packages 10, 20 comprise the door assembly elements 11, 21 for both sliding door leaves 2. The other sliding doors 1 represented in FIG. 1 have the following modifications, among others:

In the case of a single-leaf sliding door 1, the drive assembly elements 31, 41 are not divided into two parts. A first drive package 30 for a single-leaf door (not represented) contains only a one-part cladding and thus only one drive assembly element 31. The door packages 10, 20 only contain the door assembly elements 11, 21 for one sliding door leaf 2.

If a side part 3 is present, as represented in FIG. 1 top right, the design kit also comprises a first and a second side package (not represented), which is constructed in the same way as the door packages 10, 20 for a single-leaf door. The two side packages form a package bundle, as represented in FIG. 8.

If two side parts 3 are present, as represented in FIG. 1 bottom left, the design kit also comprises two package bundles each consisting of a first and a second side package (not represented), each of which is constructed in the same way as the door packages 10, 20 for a single-leaf door. The two side packages for a side part form a package bundle, as represented in FIG. 8.

FIG. 12 shows one of the door profiles 12 in different views. It is thereby shown that the door profile 12 preferably has a recess 51 on one side. This recess 51 is produced before the design kit 9 is compiled and sent. Therefore, after sending and therefore before installation of the sliding door 1, the corresponding door profile 12 only needs to be shortened and provided with holes. The recess 51 with the relatively complicated geometry is already located in the door profile 12. The recess is used to receive a floor guide rail.

FIG. 12 illustrates purely schematically that after shortening the door profile 12, corresponding holes can be introduced on the side where it has been shortened by means of a template 52, which is preferably part of the design kit 9.

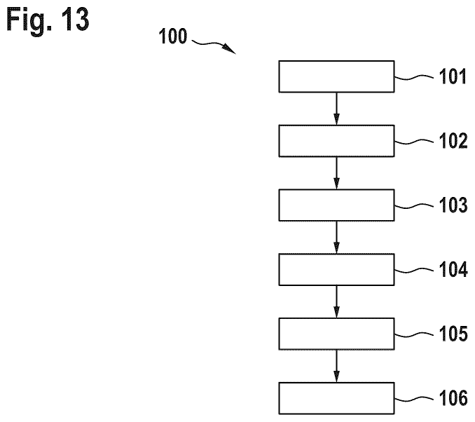

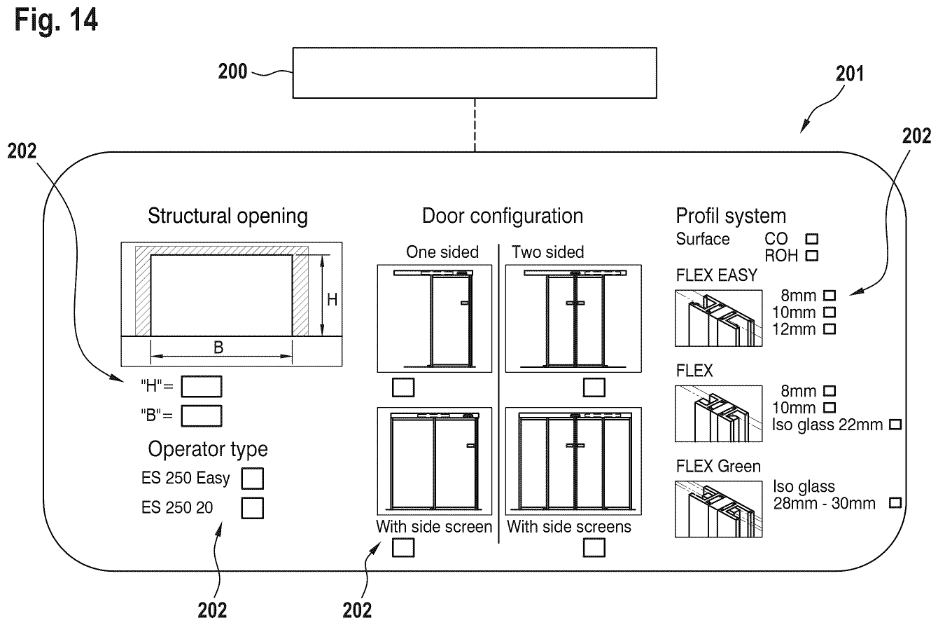

FIG. 13 shows purely schematically method steps 101 to 106 of the method 100 for preparing the production of the automatic sliding door 1. FIG. 14 shows purely schematically what a user interface of a configuration system 201 can look like. Such a configuration system 201 is used as part of the method 100 and is thereby part of a computer arrangement 200. The configuration system 201 can be used to record different user specifications 202.

Method step 105 describes the compiling of the design kit 9 as described above. Method step 106 describes the collective sending of the plurality of packages of the design kit 9.

Prior to compiling 105 and sending 106, the following optional steps are provided:
101: Using the computer arrangement 200, in which data relating to a plurality of pre-configured design kits is stored, with a plurality, in particular each, of the stored pre-configured design kits corresponding to the design kit 9, with the pre-configured design kits differing in at least one parameter specific to the door assembly 4 and/or the drive assembly 5 and/or the motor assembly and/or the specification of the sliding door to be produced.
102: Making available, in particular operating, the configuration system 201 which is operated on the computer arrangement 200 and on which a user can select and/or indicate a plurality of user specifications 202.
103: Assigning, by means of the computer arrangement 200, a pre-configured design kit to the user specifications 202, with it being stored in the computer arrangement 200 and/or being able to be determined by the computer arrangement 200 which pre-configured design kit is assigned or is to be assigned to which combination of user specifications 202
104: Issuing, by means of the computer arrangement 200, the assigned pre-configured design kit, in particular with an overall order number for the entire pre-configured design kit.

In particular, the configuration system 201 is designed to comprise the spatial dimensions of the opening to be closed by the sliding door 1 as user specifications 202 to be selected and/or indicated. This can be entered in FIG. 14 on the left under the heading “structural opening”: the user can enter the height of the opening in the building in the “H” field and the width of the opening in the building in the “B” field.

As represented in the centre of FIG. 14, the specifications of the sliding door 1 can be selected. Here the user has four options to choose from, namely single-leaf without side part, double-leaf without side part, single-leaf with side part, double-leaf with side parts. These options are represented in FIG. 14 from top left to bottom right in this order by means of a corresponding illustration. The user can click on the corresponding box in the corresponding illustration.

As represented on the right in FIG. 14, the user can select different thicknesses of glass panes. In addition, further specifications of the door profiles 12; and/or specifications of the cladding 32 can be selected.

The specifications of the motor assembly can be selected at the bottom left of FIG. 14.

In particular, the configuration system 201 is designed to determine a target length of the at least one door assembly element and/or the at least one drive assembly element based on the user specifications 201, with the at least one door assembly element and/or the at least one drive assembly element being sent with an actual length that is greater than the target length, and with the configuration system 201 being designed to issue an instruction that describes the shortening to the target length.

The following optional method steps are also provided:

Prior to compiling 105: Carrying out a material-removal step on at least one of the door profiles 12, in particular introducing the recess 51 to receive a floor guide rail.

After sending 106: Coating the first door assembly elements 11 and/or first drive assembly elements 31.

After sending 106: Shortening at least one door assembly element and/or drive assembly element to the target length, preferably according to the instruction.

After sending 106: Introducing at least one hole in at least one door assembly element and/or drive assembly element by means of the template 52.

After sending 106: Placing together, in particular connecting, at least one drive assembly element sent in two parts.

The method can comprise assembling the sliding door 1.

1. A design kit for producing an automatic sliding door for a building, comprising at least the following assemblies:
at least one door assembly with a plurality of door assembly elements for at least one sliding door leaf,
a drive assembly with a plurality of drive assembly elements, and
a motor assembly with a plurality of motor assembly elements, wherein the design kit is divided into a plurality of packages.

2. The design kit according to claim 1,
wherein at least one package is provided for each assembly,
and/or wherein each package comprises an outer packaging made of cardboard and/or film,
and/or wherein a package bundle is formed from at least two packages of the assembly for at least one assembly.

3. The design kit according to claim 1, wherein the door assembly elements are composed of first door assembly elements and second door assembly elements, wherein the packages comprise:
a first door package with first door assembly elements, comprising door profiles, wherein the first door assembly elements are intended for coating, and
a second door package with second door assembly elements, in particular comprising door seals and/or small door parts, wherein the second door assembly elements are not intended for coating.

4. The design kit according to claim 3,
wherein the first and second door packages have the same package length and/or the same package width.

5. The design kit according to claim 1, wherein the drive assembly elements are composed of a first drive assembly element or first drive assembly elements and second drive assembly elements, wherein the packages comprise:
a first drive package with the first drive assembly element or the first drive assembly elements, comprising a cladding, wherein the first drive assembly element or the first drive assembly elements are intended for coating, and
a second drive package with second drive assembly elements, comprising a drive profile and/or a running profile and/or a mounting plate and/or small drive parts, wherein the second drive assembly elements are not intended for coating.

6. The design kit according to claim 5,
wherein the first and second drive packages have the same package length and/or the same package width.

7. The design kit according to claim 1, wherein the motor assembly comprises as motor assembly elements a motor unit and/or at least one carriage and/or a locking unit and/or a battery unit and/or small motor parts, wherein the packages comprise:
a plurality of motor assembly packages, all compiled in a package bundle or one motor assembly package.

8. The design kit according to claim 1, wherein at least one door assembly element and/or drive assembly element is designed to be modified after unpacking and prior to putting together the automatic sliding door, to be shortened in length, to introduce holes and/or to be coated, wherein the modification is limited to shortening, introducing holes and/or coating.

9. The design kit according to claim 1, wherein at least one of the door assembly elements, at least one of the door profiles, has been subjected to a material-removal method step prior to sending, the door assembly element comprises a recess for receiving a floor guide rail.

10. The design kit according to claim 1, wherein the design kit for producing the automatic sliding door is designed as a double-leaf sliding door with a first sliding door leaf and with a second sliding door leaf, wherein at least one drive assembly element, the drive profile and/or the running profile and/or the cladding and/or the mounting plate, is in two parts, wherein the two parts are designed to be placed together in order to form the drive assembly element over its entire length.

11. The design kit according to claim 1, wherein the design kit for producing the automatic sliding door is designed as a double-leaf sliding door with a first sliding door leaf and with a second sliding door leaf, wherein the first and the second door package each comprise the door assembly elements for both sliding door leaves and/or wherein the first and the second drive package each comprise the drive assembly elements for both sliding door leaves.

12. A method for preparing the production of an automatic sliding door for a building, the method including the following steps:
Compiling the design kit according to claim 1, and
Sending the plurality of packages of the design kit.

13. The method according to claim 12, wherein the method comprises the following steps prior to compiling and sending:
Using a computer arrangement, in which data relating to a plurality of pre-configured design kits is stored, wherein a plurality of the stored pre-configured design kits corresponds to the design kit, wherein the pre-configured design kits differ in at least one design, in particular parameters, specific to the door assembly and/or the drive assembly and/or the motor assembly,
Making available operating, a configuration system which is operated on the computer arrangement and on which a user can select and/or indicate a plurality of user specifications,
Assigning, by means of the computer arrangement, a pre-configured design kit to the user specifications, wherein it is stored in the computer arrangement and/or can be determined by the computer arrangement which pre-configured design kit is to be assigned to which combination of user specifications,
Issuing, by means of the computer arrangement, the assigned pre-configured design kit, with an overall order number for the entire pre-configured design kit.

14. The method according to claim 13, wherein the configuration system is designed such the user specifications to be selected and/or indicated comprise:
spatial dimensions of the opening to be closed by the sliding door,
and/or specifications of the sliding door, single-leaf, double-leaf, weight of the sliding door, seals on the sliding door,
and/or specifications of the door profiles,
and/or specifications of the cladding,
and/or specifications of the motor assembly.

15. The method according to claim 12, wherein the configuration system is designed to determine a target length of the at least one door assembly element and/or of the at least one drive assembly element based on the user specifications, wherein the at least one door assembly element and/or the at least one drive assembly element is sent with an actual length which is greater than the target length, and wherein the configuration system is designed to issue an instruction which describes the shortening to the target length.

16. The method according to claim 12, comprising:
prior to compiling: Carrying out a material-removal step on at least one of the door profiles, introducing a recess for receiving a floor guide rail; and/or
after sending: Coating the first door assembly elements and/or first drive assembly elements; and/or
after sending: Shortening at least one of the door assembly elements and/or drive assembly elements to the target length, according to the instruction; and/or
after sending: Introducing at least one hole in at least one of the door assembly elements and/or drive assembly elements by means of a template; and/or
after sending: Placing together, connecting, at least one of the two-part drive assembly elements.
